(19) United States
(12) Patent Application Publication
(10) Pub. No.: US 2026/0343650 A1
(43) Pub. Date: Oct. 29, 2026

(54) MULTI-LINK RECONFIGURATION AND TIM BROADCAST PROCEDURE FOR MULTI-LINK OPERATION

(71) Applicant: Samsung Electronics Co., Ltd., Suwon-si (KR)

(72) Inventors: Rubayet Shafin, Allen, TX (US); Boon Loong Ng, Plano, TX (US); Vishnu Vardhan Ratnam, Plano, TX (US); Peshal Nayak, Plano, TX (US)

(21) Appl. No.: 19/726,453

(22) Filed: Jun. 30, 2026

Related U.S. Application Data
(63) Continuation of application No. 18/365,144, filed on Aug. 3, 2023.
(60) Provisional application No. 63/399,896, filed on Aug. 22, 2022.
(60) Provisional application No. 63/420,372, filed on Oct. 28, 2022.

(51) Int. Cl. H04W 76/15

(52) U.S. Cl. CPC H04W 76/15

(57) ABSTRACT

Methods and apparatuses for facilitating automatic re-establishment of a link by multi-link devices (MLDs) in a wireless local area network. A non-access point (AP) MLD comprises a processor and stations (STAs), each comprising a transceiver configured to form a link with a corresponding AP of an AP MLD with which the non-AP MLD is associated. The transceiver of one of the STAs is further configured to receive, from the corresponding AP of the AP MLD, a first message that includes an announcement of addition of a new AP to the AP MLD. The processor is operably coupled to the STAs and is configured to determine to establish a new link between the new AP and the transceiver of a first of the STAs.

### CROSS-REFERENCE TO RELATED APPLICATION AND CLAIM OF PRIORITY

This application is a continuation of U.S. application Ser. No. 18/365,144 filed Aug. 3, 2023, which claims priority under 35 U.S.C. § 119(e) to U.S. Provisional Patent Application No. 63/399,896 filed on Aug. 22, 2022, and to U.S. Provisional Patent Application No. 63/420,372 filed on Oct. 28, 2022, which are hereby incorporated by reference in their entirety.

### TECHNICAL FIELD

This disclosure relates generally to multi-link operation in wireless communications systems that include multi-link devices. Embodiments of this disclosure relate to methods and apparatuses for multi-link reconfiguration in a wireless local area network communications system.

### BACKGROUND

Wireless local area network (WLAN) technology allows devices to access the internet in the 2.4 GHz, 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA).

### SUMMARY

Embodiments of the present disclosure provide methods and apparatuses for facilitating automatic re-establishment of a link between a STA affiliated with a non-AP MLD and a newly added AP affiliated with an AP MLD in a WLAN.

In one embodiment, a non-AP MLD is provided, comprising STAs and a processor operably coupled to the STAs. The STAs each comprise a transceiver configured to form a link with a corresponding AP of an AP MLD with which the non-AP MLD is associated. The transceiver of one of the STAs is further configured to receive, from the corresponding AP of the AP MLD, a first message that includes an announcement of addition of a new AP to the AP MLD. The processor is configured to determine to establish a new link between the new AP and the transceiver of a first of the STAs.

In another embodiment, a method of wireless communication performed by a non-AP MLD that comprises STAs is provided. The STAs each comprise a transceiver configured to form a link with a corresponding AP of an AP MLD with which the non-AP MLD is associated. The method comprises the steps of receiving, from the corresponding AP of the AP MLD, a first message that includes an announcement of addition of a new AP to the AP MLD, and determining to establish a new link between the new AP and the transceiver of a first of the STAs.

In another embodiment, an AP MLD is provided, comprising APs and a processor operably coupled to the APs. The APs each comprise a transceiver configured to form a link with a corresponding STA of a non-AP MLD with which the AP MLD is associated. The processor is configured to generate a first message that includes an announcement of addition of a new AP to the AP MLD. The transceiver of one of the APs is further configured to transmit, to the corresponding STA of the non-AP MLD, the first message. A new link is established between the transceiver of the new AP and a first of the STAs of the non-AP MLD after the first message is received at the non-AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIGS. 3A-3D illustrate an example process for a non-AP MLD to request setup of a link with a newly added AP of an AP MLD according to embodiments of the present disclosure;

FIGS. 4A-4B illustrate an example process for automatic re-establishment of a link with a newly added AP of an AP MLD according to embodiments of the present disclosure;

FIG. 5 illustrates an example format of a Common Info field of the Basic Multi-Link element for MLD-level automatic link re-establishment capability indication according to embodiments of the present disclosure;

FIG. 6 illustrates an example format of a Per-STA Profile sub-element of the Basic Multi-Link element for STA-level automatic link re-establishment capability indication according to embodiments of the present disclosure;

FIG. 7 illustrates an example of AP addition time indication through beacons and Probe Response frames according to embodiments of the present disclosure;

FIG. 8 illustrates an example format of the STA Control field of the Per-STA Profile sub-element of the Reconfiguration Multi-Link element according to embodiments of the present disclosure;

FIG. 9 illustrates an example format of the STA Info field of the Per-STA Profile sub-element of the Reconfiguration Multi-Link element according to embodiments of the present disclosure;

FIG. 10 illustrates an example of an MLO critical update procedure from the AP MLD point of view according to embodiments of the present disclosure;

FIG. 11 illustrates an example of an MLO critical update procedure using TIM Broadcast according to embodiments of the present disclosure;

FIG. 12 illustrates an example format of an EHT Variant TIM Action field according to embodiments of the present disclosure;

FIG. 13 illustrates an example process for use of an EHT Variant TIM Action field from an AP MLD point of view according to embodiments of the present disclosure;

FIG. 14 illustrates an example process for use of an EHT Variant TIM Action field from a non-AP MLD point of view according to embodiments of the present disclosure;

FIG. 15 illustrates an example format of an EHT Variant TIM Action field enabling multiple link indication according to embodiments of the present disclosure;

FIG. 16 illustrates another example format of an EHT Variant TIM Action field enabling multiple link indication according to embodiments of the present disclosure; and

FIG. 17 illustrates an example process for facilitating automatic re-establishment of a link between a STA affiliated with a non-AP MLD and a newly added AP affiliated with an AP MLD according to various embodiments of the present disclosure.

### DETAILED DESCRIPTION

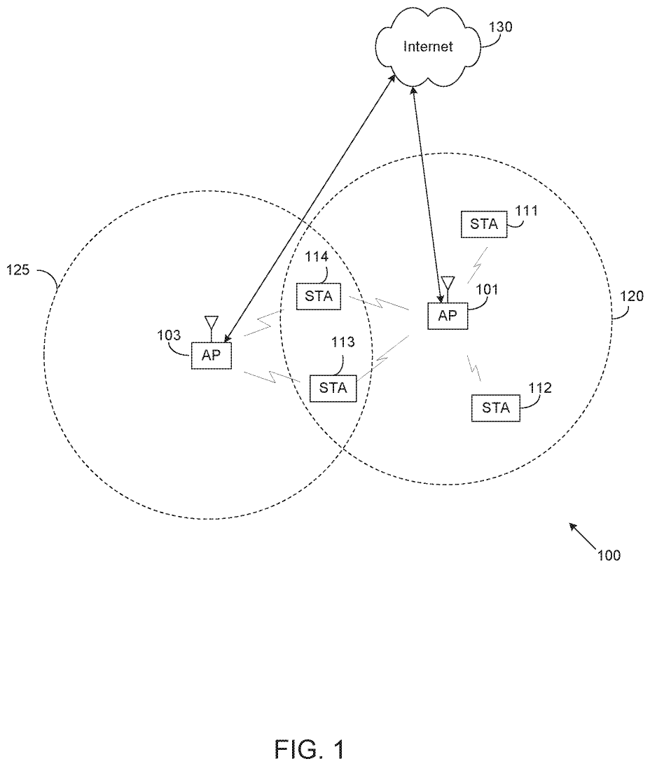

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Multi-Link (ML) reconfiguration refers to a set of procedures through which an AP MLD can add one or more affiliated APs to the AP MLD or remove one or more affiliated APs from the AP MLD.

When an AP MLD adds one or more affiliated APs to the AP MLD, each added affiliated AP is announced through the Basic Multi-Link element (by changing the Maximum Number Of Simultaneous Links subfield of the MLD Capabilities and Operations subfield), and through the Reduced Neighbor Report element (by including a TBTT Information field with MLD Parameter field for the added AP), in the Beacon and Probe Response frames transmitted by other APs affiliated with the same AP MLD.

When an AP MLD removes one or more of its affiliated APs, the AP MLD announces the removal of any affiliated AP through a Reconfiguration Multi-Link element transmitted in all Beacon frames of all its affiliated APs, as well as all Probe Response frames it transmits, until the affiliated AP has been removed.

For each affiliated AP that the AP MLD intends to remove, the Reconfiguration Multi-Link element includes a Per-STA Profile sub-element with the subfields of the Per-STA Control field set as follows: The Link ID subfield shall identify the AP, the Complete Profile subfield shall be set to 0, the Delete Timer Present subfield shall be set to 1, and the Delete Timer subfield shall be set to the number of target beacon transmission times (TBTTs) of that affiliated AP before it is removed. The initial value of the Delete Timer subfield shall be longer than the MLD max idle period. The Per-STA Profile sub-element shall not include a STA Profile field.

At the TBTT indicated by the value of the Delete Timer subfield in transmitted Reconfiguration Multi-Link elements, the AP MLD removes the affiliated AP indicated by the Link ID subfield in the STA Control field of the Per-STA Profile sub-element that includes the Delete Timer subfield. Additionally, the AP MLD shall disassociate a non-AP MLD if the link corresponding to the removed AP is the only setup link between the AP MLD and the non-AP MLD.

Also at the TBTT indicated by the value of the Delete Timer subfield in transmitted Reconfiguration Multi-Link elements, an associated non-AP MLD shall consider the link corresponding to the removed AP to be nonexistent, and the SME of the affiliated non-AP STA that is associated with the removed affiliated AP shall delete any information maintained for that link. After a non-AP MLD deletes any information maintained for the link corresponding to the removed AP, if there are no other setup links with the AP MLD, then the non-AP MLD shall disassociate from the AP MLD.

Embodiments of the present disclosure recognize that the behavior of the non-AP MLD upon receiving the notification from the AP MLD that a new link has been added is not currently clear. Embodiments of the present disclosure further recognize that there is no procedure defined that would enable a non-AP MLD to automatically re-establish a link between a STA affiliated with the non-AP MLD and a newly added AP affiliated with the AP MLD when the link was previously set up between the AP and the non-AP STA before the AP MLD removed the AP. Such a procedure would reduce the overhead in frame exchanges needed to re-setup links between the newly added AP and the corresponding STAs affiliated with non-AP MLDs.

Accordingly, embodiments of the disclosure provide mechanisms for facilitating automatic re-establishment of a link between a STA affiliated with a non-AP MLD and a newly added AP affiliated with the AP MLD.

Whenever there is a critical update on any of the APs affiliated with an AP MLD (e.g., adding a new affiliated AP to the AP MLD), each of the APs will include a BSS Parameters Change Count subfield in either the Beacon frames (in the MLD parameters subfield of an RNR corresponding to the AP), Probe Response frames (in the MLD parameters subfield of an RNR corresponding to the AP), or Association/Reassociation Response frames (in the Per-STA Profile of the Basic Multi-Link element corresponding to the AP) transmitted by the APs. The BSS Parameters Change Count subfield value will be incremented for the AP whose BSS (basic service set) operational parameters have changed. An AP will set the Critical Update flag in the Beacons it transmits whenever any AP affiliated with the same AP MLD has a critical update.

At the non-AP MLD, after receiving BSS Parameters Change Count subfield for an AP which has been incremented since the last time the subfield was received by the non-AP MLD, the STA associated with the AP attempts to receive the Beacon or Probe Response frame from the AP, and any STA affiliated with the non-AP MLD attempts to send a probe request frame to retrieve the updated information from the AP.

Traffic Information Map (TIM) Frames are usually shorter than Beacons and transmitted with higher data rate. Using a TIM Broadcast a STA can skip Beacons and, hence, can save power. TIM Broadcast can be set up using a Request-Response based approach, where TIM Broadcast Interval is a negotiated parameter. Once the TIM Broadcast Interval is settled, a sequence of Target TIM Transmission Times (TTTTs) is set.

TIM frames can also be used to indicate an MLO critical update. In such a case, the AP will increase the value of the Check Beacon field of the TIM frame when a critical update occurs. The non-AP STA that receives the TIM frame then attempts to receive the subsequent Beacon to retrieve the critical information. In MLO, when a critical update occurs on any AP affiliated with an AP MLD, all the APs affiliated with the AP MLD will increase the value of the Check Beacon field of their respective TIM frame. Embodiments of the present disclosure recognize that when a STA affiliated with a non-AP MLD activates TIM Broadcast (e.g., to save power), it may unnecessarily attempt to retrieve critical information in response to a TIM frame although there may not be any relevant critical information for that non-AP MLD. For example, when a STA affiliated with a non-AP MLD receives a TIM frame that indicates a critical update, the STA will wake up to retrieve critical information even if none of the STAs affiliated with the non-AP MLD have a setup link with the AP that has a critical update.

Accordingly, embodiments of the disclosure provide mechanisms for facilitating identification, by a STA of a non-AP MLD, of the link for which a critical update indicated by a TIM frame is applicable.

Embodiments of the present disclosure further recognize that a non-AP MLD may want to disable or delete one or more of the links that the non-AP MLD has established with the AP MLD (e.g., for power saving or measurement purposes). Currently, a non-AP MLD cannot also request link deletion. Instead, if a non-AP MLD wants to remove or delete a link from the set of links within the setup links that it has established with the AP MLD, then the non-AP MLD needs to disassociate with the AP MLD first and then send a new association request with the reduced set of links. This disassociation and association take a long time to be effective.

Accordingly, embodiments of the disclosure provide mechanisms for facilitating a non-AP MLD requesting a link to be deleted from its setup links.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating automatic re-establishment of a link between a STA affiliated with a non-AP MLD and a newly added AP affiliated with an AP MLD in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

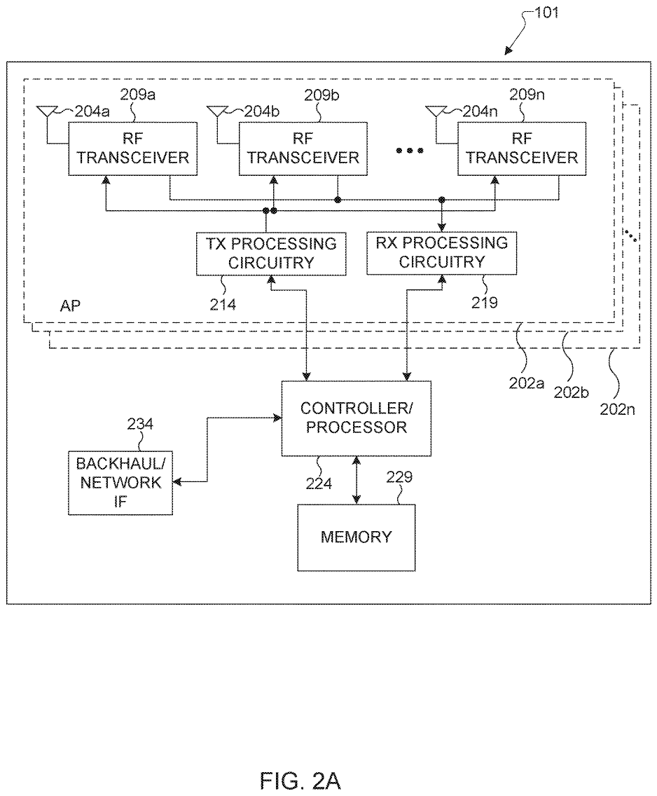

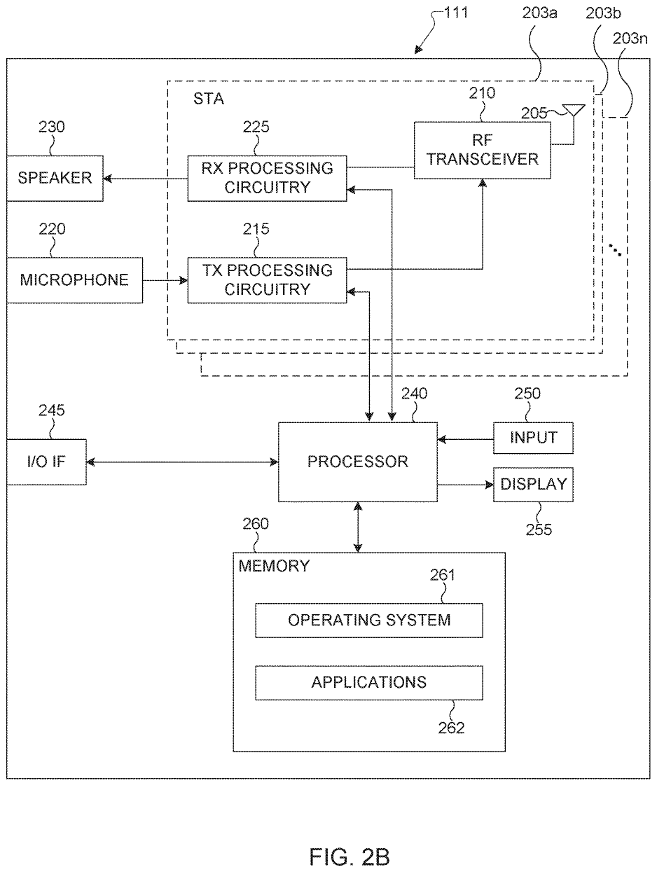

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating automatic re-establishment of a link between a STA affiliated with a non-AP MLD and a newly added AP affiliated with an AP MLD in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating automatic re-establishment of a link between a STA affiliated with a non-AP MLD and a newly added AP affiliated with an AP MLD in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives, from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate automatic re-establishment of a link between a STA affiliated with a non-AP MLD and a newly added AP affiliated with an AP MLD in WLANs. In some embodiments, the controller/processor 240 includes at least one microprocessor or microcontroller.

The controller/processor 240 is also capable of executing other processes and programs resident in the memory 260, such as operations for facilitating automatic re-establishment of a link between a STA affiliated with a non-AP MLD and a newly added AP affiliated with an AP MLD in WLANs. The controller/processor 240 can move data into or out of the memory 260 as required by an executing process. In some embodiments, the controller/processor 240 is configured to execute a plurality of applications 262, such as applications for facilitating automatic re-establishment of a link between a STA affiliated with a non-AP MLD and a newly added AP affiliated with an AP MLD in WLANs. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure provided herein below enable a non-AP MLD to automatically re-establish a link between a STA affiliated with the non-AP MLD and a newly added AP affiliated with the AP MLD when the link was previously set up between the AP and the non-AP STA before the AP MLD removed the AP.

As noted above, when an AP MLD adds one or more new affiliated APs to the AP MLD, each added affiliated AP is announced by the other APs affiliated with the same AP MLD in Beacon and Probe Response frames. In one embodiment, when an AP MLD announces in its BSS that a new AP has been added (and the new AP is affiliated with the same AP MLD), a non-AP MLD in the BSS, upon observing the announcement from the AP MLD, can send a request to the AP MLD for setting up a link between the newly added AP affiliated with the AP MLD and a corresponding STA affiliated with the non-AP MLD. Upon receiving the request from the non-AP MLD, the AP MLD can either accept the request to establish the link or reject the request, and the AP MLD can send a response frame to indicate acceptance or rejection of the request.

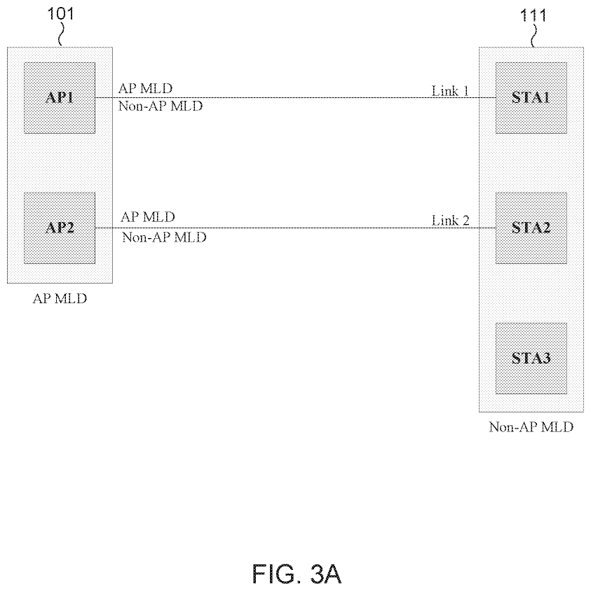

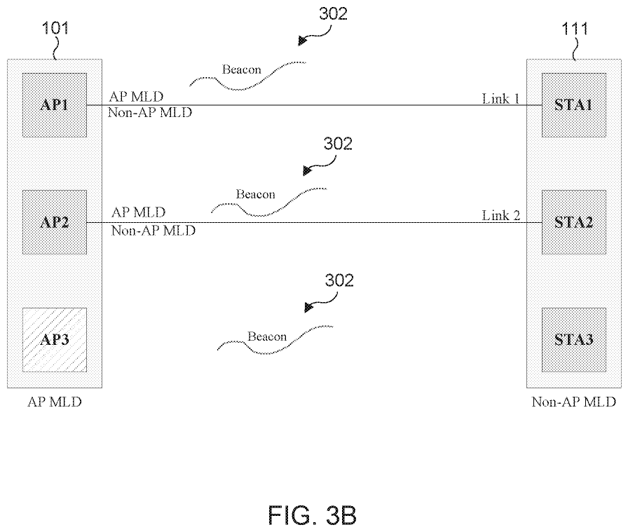

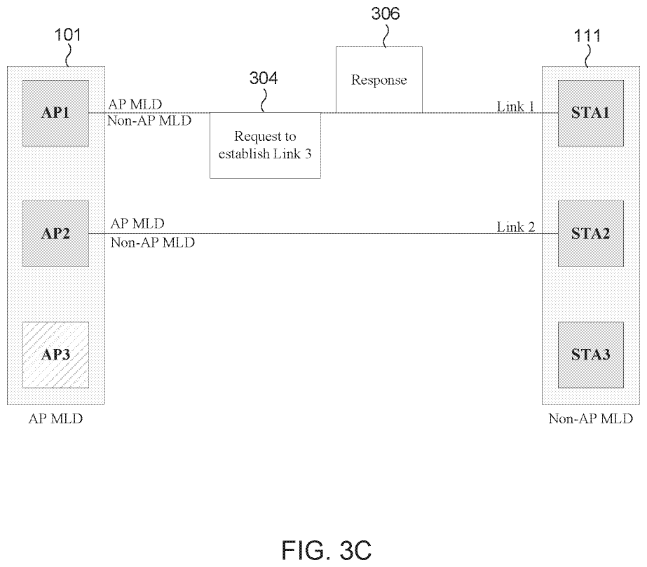

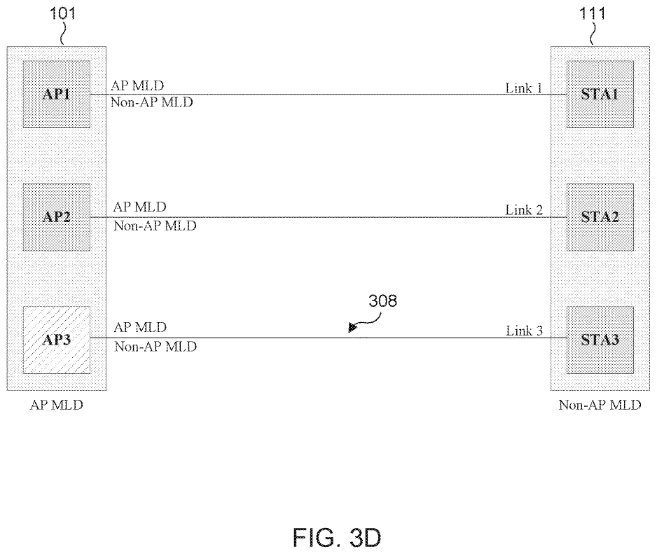

FIGS. 3A-3D illustrate an example process for a non-AP MLD to request setup of a link with a newly added AP of an AP MLD according to embodiments of the present disclosure. In this example, the AP MLD may be an AP MLD 101, and the non-AP MLD may be a non-AP MLD 111. Although the AP MLD 101 is illustrated as an AP MLD with two affiliated APs initially and the non-AP MLD 111 is illustrated as a non-AP MLD with three affiliated non-AP STAs, it is understood that this process could be applied with suitable MLDs having any number of affiliated APs or STAs. For ease of explanation, it is understood that references to an AP MLD and a non-AP MLD in further embodiments below refer to the AP MLD 101 and non-AP MLD 111, respectively.

Referring to FIG. 3A, an initial state of the system is illustrated. The AP MLD initially has 2 affiliated APs (AP1 and AP2) and the non-AP MLD has 3 affiliated STAs (STA1, STA2, and STA3). Two links are setup between the AP MLD and the non-AP MLD (Link 1 between STA1 and AP1 and Link 2 between STA2 and AP2).

Referring now to FIG. 3B, the AP MLD adds a new affiliated AP (AP3) and announces the addition in its BSS. For example, the AP MLD advertises the newly added AP3 in Beacon and Probe Response frames, such as Beacon frames 302.

Referring now to FIG. 3C, after receiving the Beacon frames 302, the non-AP MLD sends a request 304 to the AP MLD to establish a third link between the newly added AP3 affiliated with the AP MLD and STA3 affiliated with the non-AP MLD. The AP MLD accepts the request from the non-AP MLD in a response frame 306 sent to the non-AP MLD.

Referring now to FIG. 3D, a new link 308 (e.g., Link 3) is established between the AP MLD and the non-AP MLD after the response frame 306 is received by the non-AP MLD.

In the above-described procedure, the request and response-based approach has an issue with overhead. For example, if there are many non-AP MLDs that send such requests to the AP MLD to establish a link with the newly added AP, it would incur significant overhead for the AP MLD and would take up significant airtime. Additionally, this approach does not consider any previous information regarding whether the non-AP MLD had previously set up a link with the newly added AP affiliated with the AP MLD.

According to one embodiment, if a STA affiliated with a non-AP MLD was previously associated with an AP that was affiliated with the AP MLD but was removed from the Ap MLD, and if the AP, after being unavailable for some time, is again added to the AP MLD, then upon re-addition of the AP to the AP MLD the link between the newly added AP and the STA can be automatically re-established. This will save significant overhead (e.g., due to request-response message exchange) in a dense network with many non-AP MLDs.

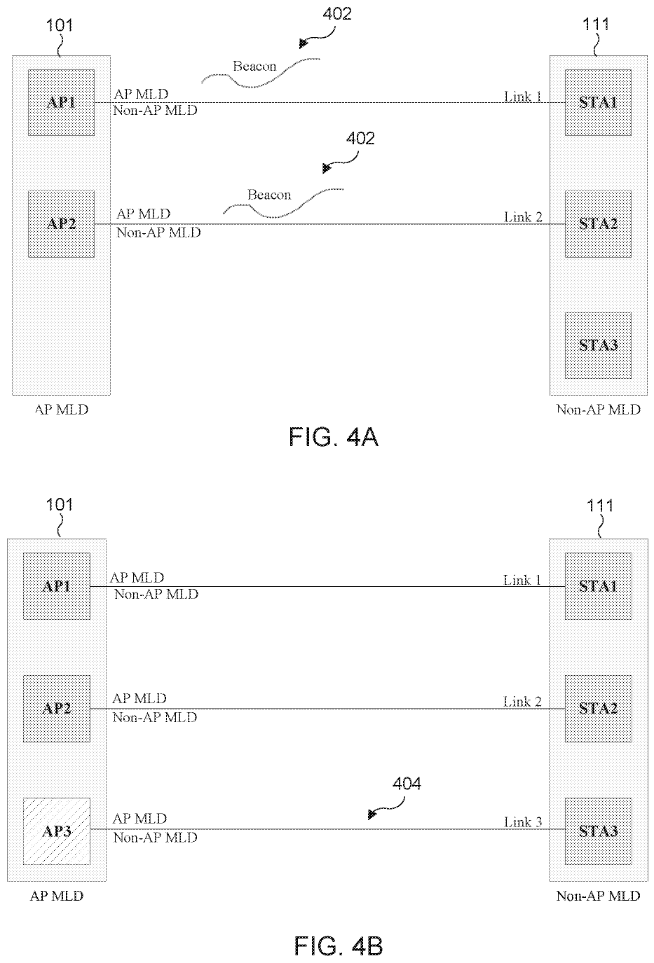

FIGS. 4A-4B illustrate an example process for automatic re-establishment of a link with a newly added AP of an AP MLD according to embodiments of the present disclosure. In an initial state of the system in this example, the AP MLD has 2 affiliated APs (AP1 and AP2) and the non-AP MLD has 3 affiliated STAs (STA1, STA2, and STA3). Two links are setup between the AP MLD and the non-AP MLD (Link 1 between STA1 and AP1 and Link 2 between STA2 and AP2). The AP MLD intends the add AP3 to the AP MLD.

Referring to FIG. 4A, the AP MLD announces the imminent addition of AP3 by including a Reconfiguration Multi-Link element in the Beacon and Probe Response frames (e.g., Beacon frames 402) it transmits on Link 1 and Link 2.

In this example, STA3 affiliated with the non-AP MLD was previously associated with AP3 when it was previously affiliated with the AP MLD. Accordingly, As illustrated in FIG. 3B, when AP3 is re-added to the AP MLD, STA3's link 404 (e.g., Link 3) with AP3 is automatically re-established.

Not all MLDs may have the capability to automatically re-establish a link when a new AP has been added to the AP MLD. According to some embodiments, an MLD that does have this capability may indicate such using a capability indication message. According to one such embodiment, this can be an MLD-level capability indication.

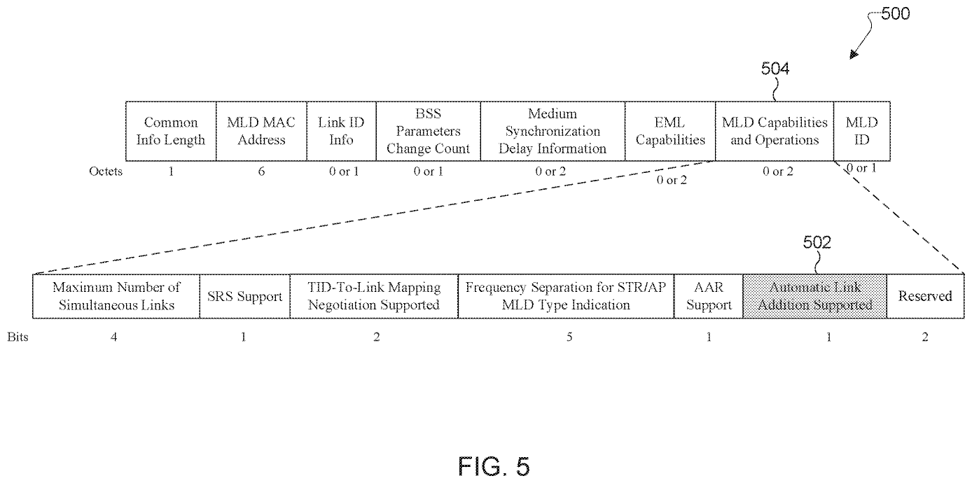

FIG. 5 illustrates an example format of a Common Info field 500 of the Basic Multi-Link element for MLD-level automatic link re-establishment capability indication according to embodiments of the present disclosure. In this example, the Automatic Link Addition Supported subfield 502 in the MLD Capabilities and Operations subfield 504 indicates whether the MLD supports automatic link addition or not. If the Automatic Link Addition Supported subfield 502 is set to 1, it indicates that all the STAs affiliated with the MLD support automatic link addition. If the subfield is set to 0, it can indicate that none of the STAs support the automatic link addition feature.

According to other embodiments, automatic link re-establishment capability can also be indicated on a per-STA basis. According one such embodiment, support for this feature can be indicated in the per-STA profile of a Basic Multi-Link element.

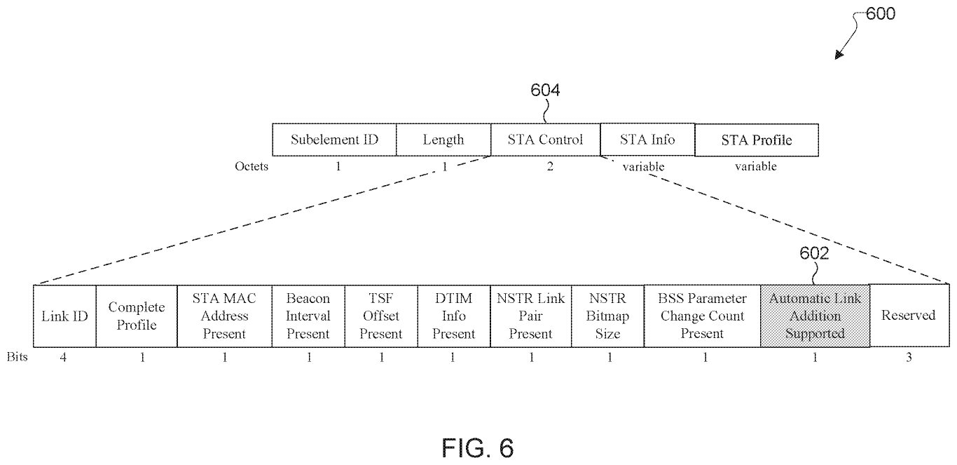

FIG. 6 illustrates an example format of a Per-STA Profile sub-element 600 of the Basic Multi-Link element for STA-level automatic link re-establishment capability indication according to embodiments of the present disclosure. In this example, if the Automatic Link Addition Supported subfield 602 in the STA Control field 604 of a Per-STA Profile sub-element of a Basic Multi-Link element is set to 1, it would indicate that the STA affiliated with the MLD and corresponding to the Per-STA Profile supports automatic link establishment. Otherwise, the STA does not support this feature.

According to one embodiment, an AP MLD, before adding a new AP, can announce ahead of time when the new AP is expected to be added. The APs affiliated with the AP MLD can announce the time of new AP addition (e.g., in terms of TBTT) in the Beacons and Probe Response frames the APs transmit. According to one embodiment, the APs affiliated with the AP MLD can start announcing the new AP addition time at least a threshold amount of time before the AP MLD adds the new AP. This may help the non-AP MLDs that intend to establish links with the new AP to better manage traffic.

According to one embodiment, the APs affiliated with the AP MLD can indicate the time of new AP addition in the Reconfiguration Multi-Link element that the APs transmit in the Beacons and Probe Response frames. For example, the AP addition time can be indicated by introducing an Add Timer subfield in the Reconfiguration Multi-Link element.

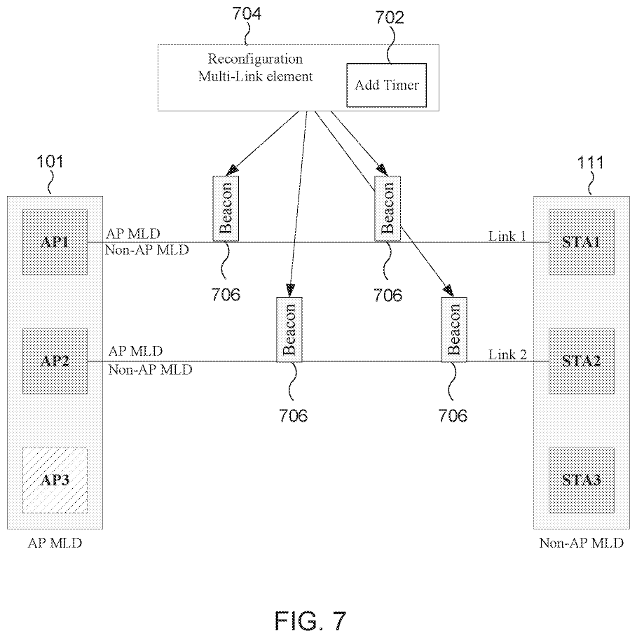

FIG. 7 illustrates an example of AP addition time indication through beacons and Probe Response frames according to embodiments of the present disclosure. In this example, an Add Timer subfield 702 is added to the Reconfiguration Multi-Link element 704 in Beacon frames 706.

The Add Timer subfield can in some embodiments be conditionally present in the Reconfiguration Multi-Link element. Its presence can be indicated by the Add Timer Present subfield of the STA Control field of the Per-STA Profile sub-element of the Reconfiguration Multi-Link element.

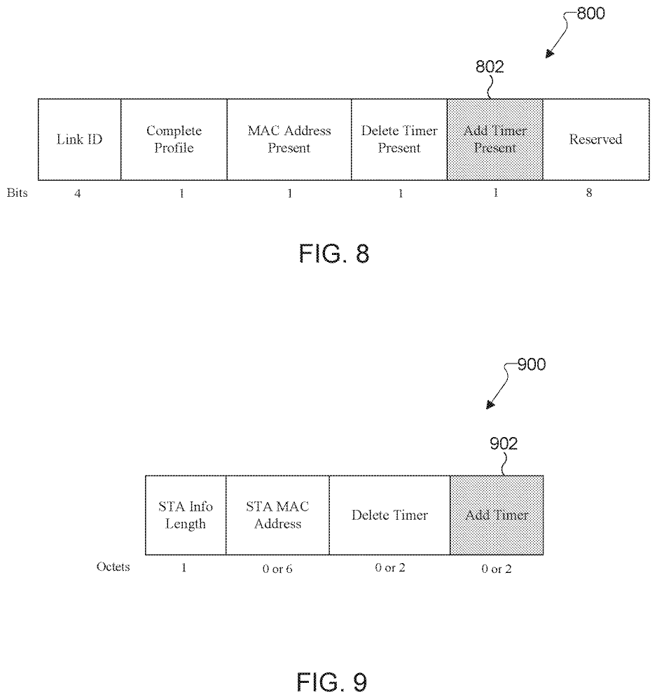

FIG. 8 illustrates an example format of the STA Control field 800 of the Per-STA Profile sub-element of the Reconfiguration Multi-Link element according to embodiments of the present disclosure. In this example, the STA Control field 800 includes the Add Timer Present subfield 802. If the Add Timer Present subfield 802 is set to 1, it indicates that the Add Timer subfield is present in the Per-STA Profile field of the Reconfiguration Multi-Link element. Otherwise, the Add Timer subfield is not present in the Per-STA Profile sub-element of the Reconfiguration Multi-Link element.

According to one embodiment, the Add Timer subfield can be present in the STA Info field of the Per-STA Profile sub-element of the Reconfiguration Multi-Link element.

FIG. 9 illustrates an example format of the STA Info field 900 of the Per-STA Profile sub-element of the Reconfiguration Multi-Link element according to embodiments of the present disclosure. In this example, the STA Info field 900 includes the Add Timer subfield 902. The Add Timer subfield 902 indicates the time, in TBTT, when the AP MLD intends to add the new AP corresponding to the Per-STA Profile sub-element of the Reconfiguration Multi-Link element.

According to one embodiment, for the scenario in which an AP MLD adds a new AP, if a STA was previously associated with the AP before the AP was removed, then after the AP is re-added, the link between the newly added AP and the STA is setup and the traffic identifiers (TIDs) mapped on the newly established link with the newly added AP can follow the same mapping as the TIDs that were mapped on the link before the AP was removed. According to another embodiment, right after the AP addition and link re-establishment, all TIDs are mapped on the re-established link. According to yet another embodiment, right after the AP is re-added the link is re-established but no TID is mapped on the link corresponding to the newly added AP.

According to another embodiment of the scenario in which an AP MLD adds a new AP, regardless of whether the STA was previously associated with the AP or not, right after a link is established or setup between the STA and the newly added AP, no TID is mapped on the link between the STA and the newly added AP.

According to another embodiment, when the non-AP MLD sends a request to establish a link with the newly added AP (e.g., as illustrated in FIG. 3C), the non-AP MLD can include a TID-to-Link mapping element along with the request frame. This TID-to-Link mapping element would indicate the TID-to-Link mapping preferred by the non-AP MLD upon establishment of the link with the newly added AP. In the corresponding response frame, the AP may indicate whether the AP MLD accepts the request to setup a link with the newly added AP and the non-AP MLD's suggested TID-to-Link mapping. The AP MLD may accept both the request to establish the link and the suggested TID-to-Link mapping, reject both the request to establish the link and the suggested TID-to-Link mapping, or accept the request to establish the link but reject the suggested TID-to-Link mapping.

According to one embodiment, in the case where the AP MLD accepts the request to establish the link but rejects the suggested TID-to-Link mapping, a link is setup between the newly added AP and a corresponding STA affiliated with the non-AP MLD, but the link is not enabled.

According to one embodiment, when the non-AP MLD sends the request to establish a link with the newly added AP, the non-AP MLD can include information on a partial TID-to-Link mapping, which would indicate the non-AP MLD's preferred TID mapping for the link corresponding to the newly added AP.

According to one embodiment, whether a STA was previously associated with an AP before the AP was removed from the AP MLD and whether the STA is eligible for automatic re-establishment of the link with the AP upon re-addition of the AP by the AP MLD can be determined based on the following criteria (or any subset of these):
Whether the BSS identifier (BSSID) of the newly added AP matches that of an AP with which the STA was previously associated.
Whether the frequency band and the operating channels of the newly added AP match that of an AP with which the STA was previously associated.
Whether the bandwidth of the newly added AP matches that of an AP with which the STA was previously associated.
Whether a subset of the information contained in the EHT Operation element corresponding to the newly added AP matches that of an AP with which the STA was previously associated.
Whether a subset of the information contained in the HE Operation element corresponding to the newly added AP matches that of an AP with which the STA was previously associated.
Whether the BSSID Information field of the Neighbor Report element corresponding to the newly added AP matches that of an AP with which the STA was previously associated.

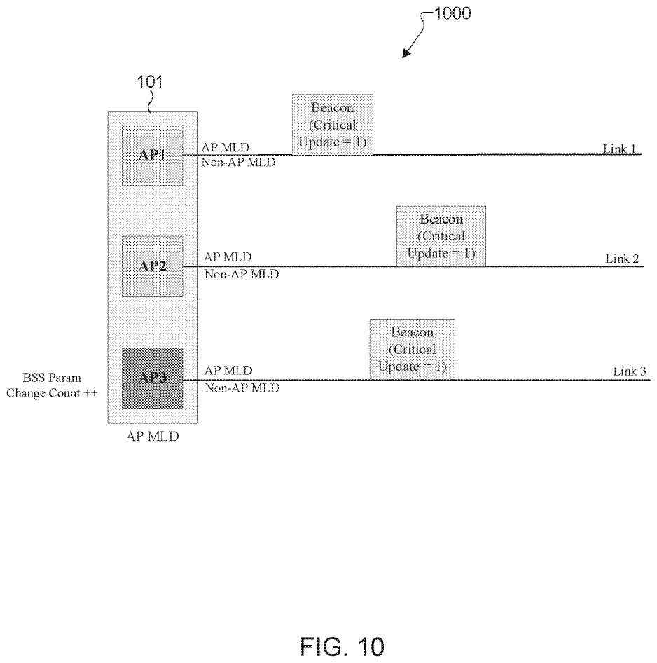

FIG. 10 illustrates an example of an MLO critical update procedure 1000 from the AP MLD point of view according to embodiments of the present disclosure. In the example procedure 1000, AP3 has a critical update. Accordingly, as discussed above, each AP affiliated with the AP MLD sets the Critical Update flag to 1 in the Beacons it transmits, and the BSS Parameters Change Count subfield for AP3 will be incremented.

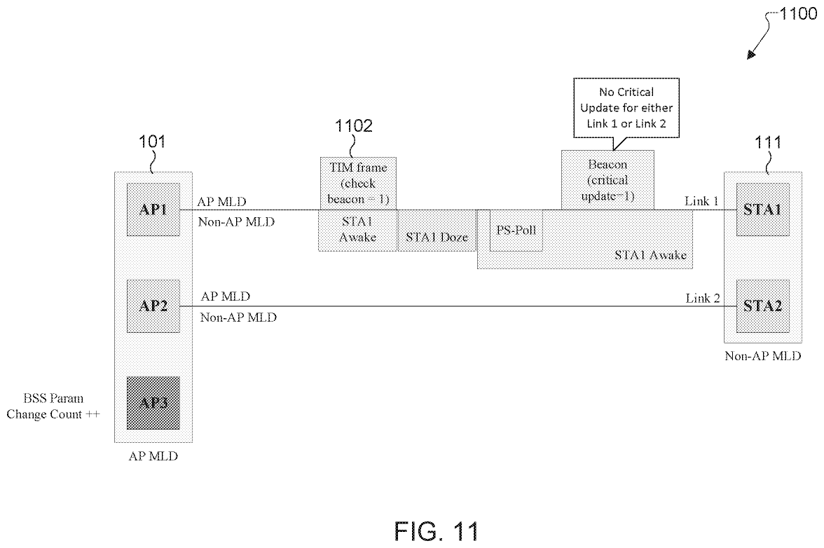

FIG. 11 illustrates an example of an MLO critical update procedure 1100 using TIM Broadcast according to embodiments of the present disclosure. In the example of FIG. 11, there are two links established between the AP MLD and the non-AP MLD-Link 1 between AP1 and STA1, and Link 2 between AP2 and STA2. The non-AP MLD is not associated with AP3 affiliated with the AP MLD.

In the example procedure 1100, AP3 has a critical update. Accordingly, as discussed above, each AP affiliated with the AP MLD increases the value of the Check Beacon subfield of its TIM frame. For example, as illustrated in FIG. 11, AP1 will set the Check Beacon subfield in the TIM frame 1102 to 1. STA1 will wake up to retrieve the critical update information only to find that—because the non-AP MLD with which STA1 is affiliated is not associated with AP3—there is no relevant information for the non-AP MLD. This will disrupt the power saving for the non-AP MLD. This same issue can also occur if a legacy STA is associated with the AP MLD in place of the illustrated non-AP MLD.

According to one embodiment, in order to address the above-described critical update indication issue with TIM Broadcast, an EHT Variant TIM Action field can be introduced. Other names may also be used to refer to the new action field. An EHT Variant TIM Action field can contain link ID information to indicate the link for which the AP MLD has a critical update.

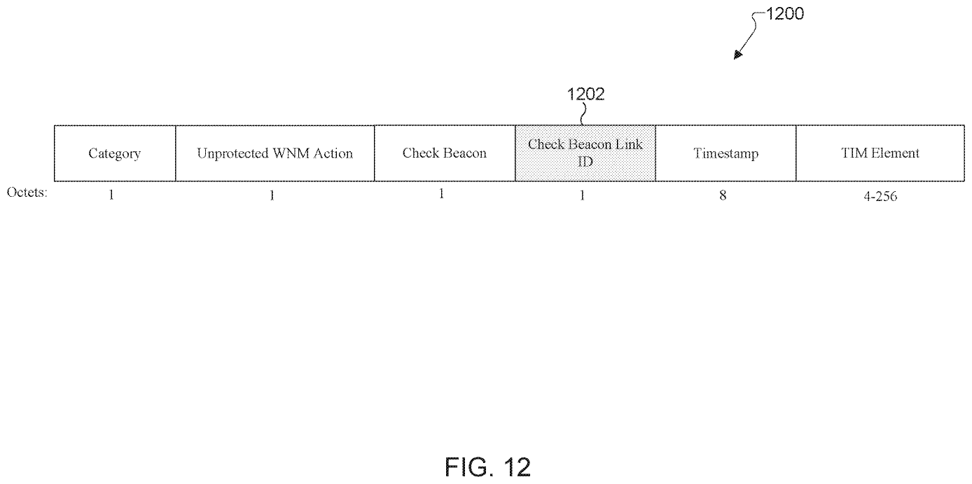

FIG. 12 illustrates an example format of an EHT Variant TIM Action field 1200 according to embodiments of the present disclosure. The example EHT Variant TIM Action field 1200 includes a Check Beacon Link ID subfield 1202. The Check Beacon Link ID subfield 1202 can indicate the link on which the operating AP affiliated with the AP MLD has a critical update.

In FIG. 12, the definitions and interpretations of the Category subfield, Unprotected WNM Action subfield, Check Beacon subfield, Timestamp subfield, and TIM Element subfield are the same as those of the existing TIM frame Action field.

According to one embodiment, with reference to FIG. 12, a non-AP MLD that is associated with an AP MLD and that receives an EHT Variant TIM Action field 1200 for a first AP affiliated with the same AP MLD and operating on a first link (e.g., Link 1) indicated in the Check Beacon Link ID subfield 1202 can attempt to retrieve the critical update from the AP MLD if the non-AP MLD has set up a link corresponding to Link 1 with the AP MLD.

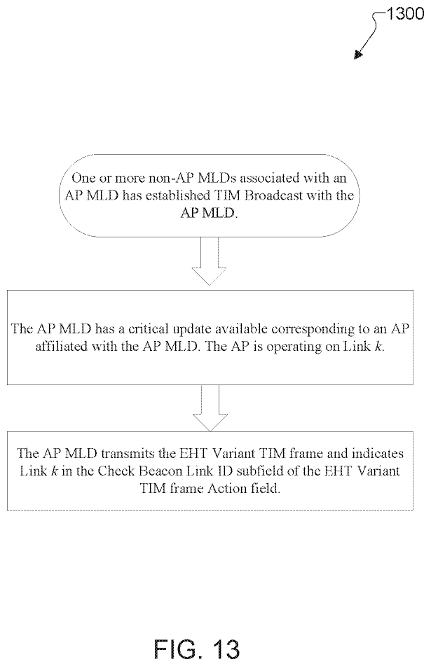

FIG. 13 illustrates an example process 1300 for use of an EHT Variant TIM Action field from an AP MLD point of view according to embodiments of the present disclosure. The EHT Variant TIM Action field used in the example process 1300 may be the EHT Variant TIM Action field 1200.

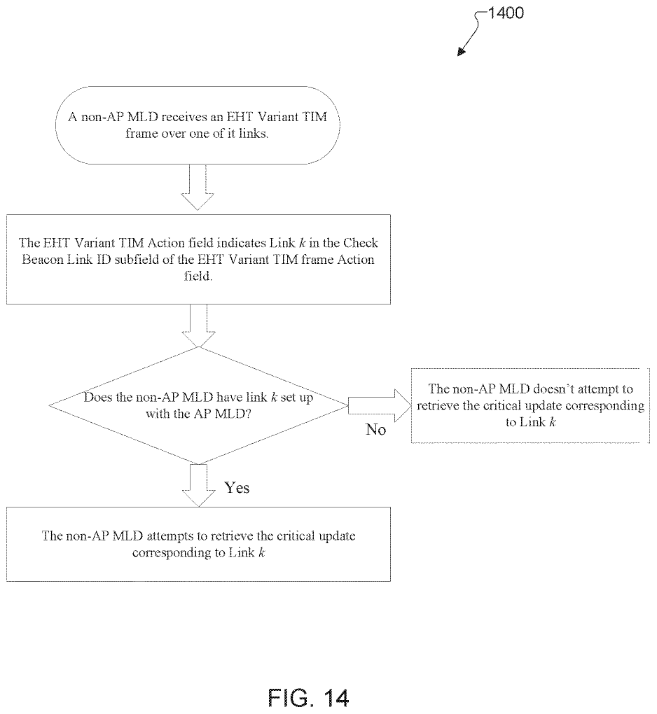

FIG. 14 illustrates an example process 1400 for use of an EHT Variant TIM Action field from a non-AP MLD point of view according to embodiments of the present disclosure. The EHT Variant TIM Action field used in the example process 1400 may be the EHT Variant TIM Action field 1200.

According to one embodiment, an EHT Variant TIM Action field can be used to indicate critical updates corresponding to multiple links on which the transmitting AP MLD is operating. In order to enable this, the EHT Variant TIM Action field can include a bitmap to indicate the links for which the critical update is present and the Beacon is suggested to be checked, and one or more TIM elements corresponding to the links indicated in the link ID bitmap of the EHT Variant TIM Action field.

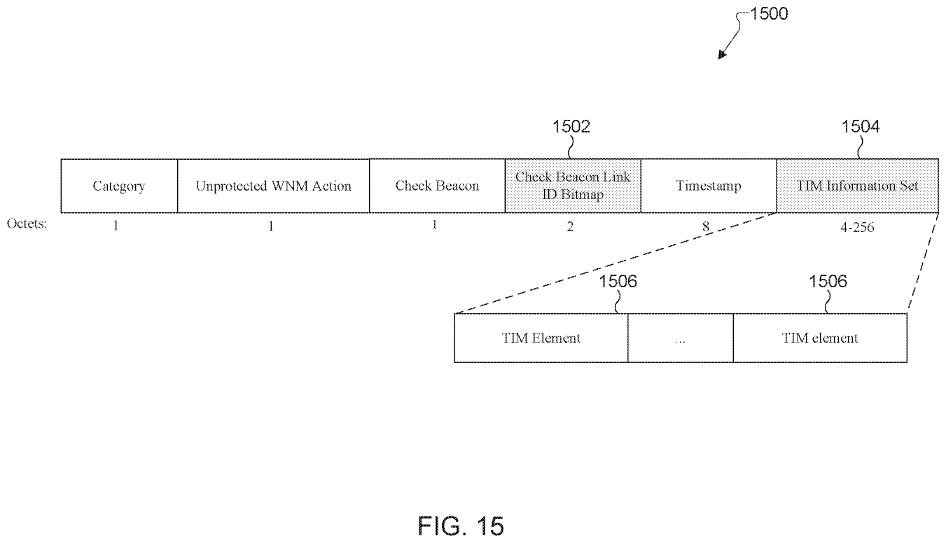

FIG. 15 illustrates an example format of an EHT Variant TIM Action field 1500 enabling multiple link indication according to embodiments of the present disclosure. The example EHT Variant TIM Action field 1500 includes a Check Beacon Link ID Bitmap subfield 1502 and a TIM Information Set 1504. The Check Beacon Link ID Bitmap subfield 1502 indicates the one or more links for which there is a critical update and for which the Beacon is requested to be checked. The TIM Information Set 1504 includes one or more TIM elements 1506 corresponding to the links indicated in the Check Beacon Link ID Bitmap subfield 1502. FIG. 15 illustrates one example format for the TIM Information Set 1504.

According to one embodiment, with reference to FIG. 15, the number of TIM elements 1506 present in the TIM Information Set 1504 can correspond to the number of ones present in the Check Beacon Link ID Bitmap subfield 1502. According to one embodiment, the first TIM element 1506 corresponds to the link corresponding to the first 1 in the Check Beacon Link ID Bitmap subfield 1502, and so on. For example, if the Check Beacon Link ID Bitmap subfield 1502 is set to 0010100000000000, then the TIM Information Set 1504 can contain two TIM elements 1506, where the first TIM element 1506 corresponds to Link 3 and the second TIM element 1506 corresponds to Link 5.

In FIG. 15, the definitions and interpretations of the Category subfield, Unprotected WNM Action subfield, Check Beacon subfield, Timestamp subfield, and TIM Element subfield are the same as those of the existing TIM frame Action field.

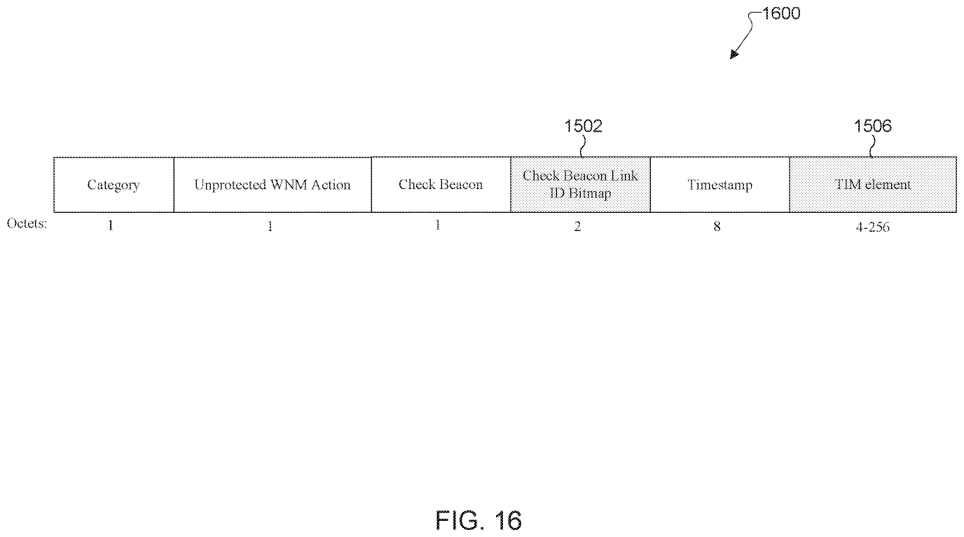

FIG. 16 illustrates another example format of an EHT Variant TIM Action field 1600 enabling multiple link indication according to embodiments of the present disclosure. In the example EHT Variant TIM Action field 1600, the same TIM element 1506 can be used for critical updates of multiple links as indicated in the Check Beacon Link ID Bitmap subfield 1502 of the EHT Variant TIM Action field 1600.

As discussed above, a non-AP MLD may want to disable or delete one or more of the links that the non-AP MLD has established with the AP MLD (e.g., for power saving or measurement purposes). According to one embodiment, a non-AP MLD that is associated with an AP MLD can send, through any enabled link between the AP MLD and the non-AP MLD, a request to the AP MLD to delete or remove a link from the set of setup links between the AP MLD and the non-AP MLD.

According to one embodiment, when a non-AP MLD sends a request for link removal, the non-AP MLD can indicate one or more links that the non-AP MLD requests to be removed. A Link ID Bitmap can be included in the Link Removal Request indicating the links that the non-AP MLD requests to delete. If a bit position i in the Link ID Bitmap is set to 1, it indicates that the non-AP MLD requests to delete the i-th link between the AP MLD and the non-AP MLD.

According to one embodiment, when a non-AP MLD sends a request to remove or delete one or more setup links, the non-AP MLD ensures that the non-AP MLD does not request to remove all the setup links between the AP MLD and the non-AP MLD.

According to one embodiment, upon receiving a Link Removal request from a non-AP MLD, the AP MLD can send to the non-AP MLD a Link Removal Response indicating whether the AP MLD accepts or rejects the request. The Link Removal Response may also suggest an alternative set of links for the link removal.

According to one embodiment, upon receiving a Link Removal Request from a non-AP MLD, if the AP MLD accepts the request, then the requested links are removed for the non-AP MLD. Other links that are not requested to be removed are not affected by the link removal of the requested links.

According to one embodiment, when a non-AP MLD sends a request to remove or delete one or more setup links, the non-AP MLD can also include link removal timing information—that is, information related to the time at which, after which, or before which the non-AP MLD requests the links to be removed.

According to one embodiment, upon receiving a Link Removal Request from a non-AP MLD that includes link removal timing information, if the AP MLD accepts the request, then the requested links are removed for the non-AP MLD at the indicated time. The AP MLD can also include the link removal timing information in the Link Removal Response frame.

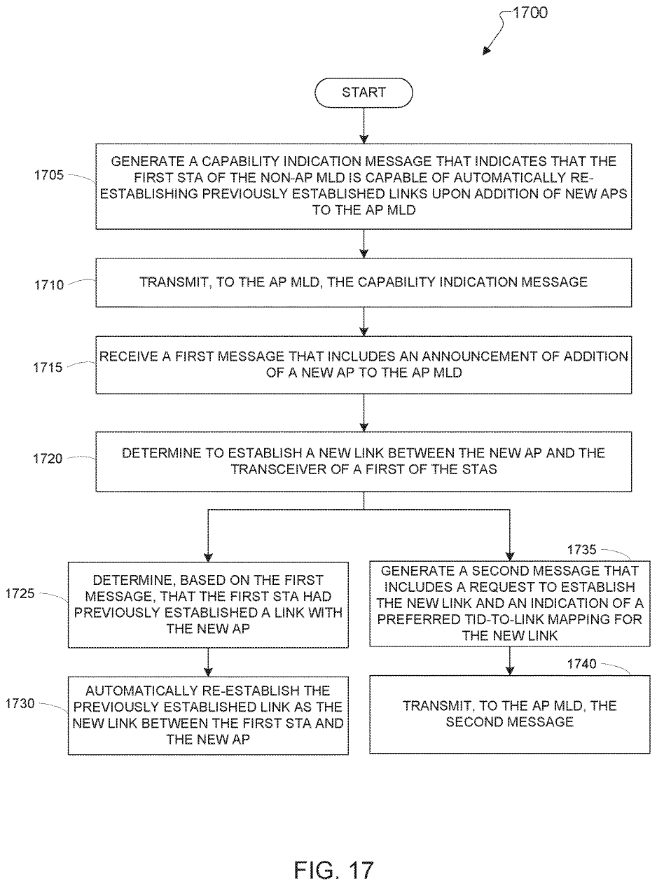

FIG. 17 illustrates an example process 1700 for facilitating automatic re-establishment of a link between a STA affiliated with a non-AP MLD and a newly added AP affiliated with an AP MLD according to various embodiments of the present disclosure. The process 1700 of FIG. 17 is discussed as being performed by a non-AP MLD, but it is understood that a corresponding AP MLD performs a corresponding process. Additionally, for convenience the process 1700 of FIG. 17 is discussed as being performed by a WI-FI non-AP MLD comprising a plurality of STAs that each comprise a transceiver configured to configured to form a link with a corresponding AP affiliated with a WI-FI AP MLD with which the non-AP MLD is associated. However, it is understood that any suitable wireless communication device could perform these processes.

Referring to FIG. 17, the process 1700 begins with the non-AP MLD generating a capability indication message that indicates that the first STA of the non-AP MLD is capable of automatically re-establishing previously established links upon addition of new APs to the AP MLD (step 1705).

The non-AP MLD then transmits the capability indication message to the AP MLD (step 1710).

Next, the non-AP MLD receives, from the AP MLD, a first message that includes an announcement of addition of a new AP to the AP MLD (step 1715). For example, the transceiver of one of the STAs of the non-AP MLD that has established a link with a corresponding AP of the AP MLD may receive the first message from the corresponding AP. In some embodiments, the first message includes an indication of a time at which the new AP will be added to the AP MLD. Additionally, the first message may be received at least a predetermined threshold amount of time before the indicated time at which the new AP will be added to the AP MLD.

The non-AP MLD then determines to establish a new link between the new AP and the transceiver of a first of the STAs (step 1720). The first STA is a STA that is not currently associated with any APs of the AP MLD. If the first message included an indication of a time at which the new AP will be added to the AP MLD, then the non-AP MLD may determine to establish the new link at or after the indicated time.

In some embodiments, the non-AP MLD determines, based on the first message, that the first STA had previously established a link with the new AP (step 1725). In that case, the non-AP MLD automatically re-establishes the previously established link as the new link between the first STA and the new AP (step 1730). If a previous TID-to-link mapping was applied to the previously established link, then the previous TID-to-link mapping may be applied to the new link.

The non-AP MLD may, at step 1725, determine whether identifying information or capability information associated with the new AP matches identifying information or capability information associated with a first AP with which the first STA was previously associated and, based on a determination that at least some of the identifying information or capability information associated with the new AP matches the identifying information or capability information associated with the first AP, determine that the first STA had previously established the link with the new AP.

In some embodiments, instead of automatically re-establishing the link, the non-AP MLD generates a second message that includes a request to establish the new link and an indication of a preferred TID-to-link mapping for the new link (step 1735). In that case, the non-AP MLD then transmits the second message to the AP MLD (step 1740).

In some embodiments, upon establishment of the new link, all TIDs are mapped to the new link. Alternatively, no TIDs are mapped to the new link upon its establishment.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point (AP) multi-link device (MLD) comprising:
stations (STAs) each comprising a transceiver configured to form a link with a corresponding AP of an AP MLD with which the non-AP MLD is associated; and
a processor operably coupled to the STAs,
wherein the transceiver of one of the STAs is further configured to receive, from the corresponding AP of the AP MLD, a first message that includes an announcement of addition of a new AP to the AP MLD, wherein a first of the STAs had previously established a link with the new AP, and
wherein the processor is configured to determine to establish a new link between the new AP and the transceiver of the first STA.

2. The non-AP MLD of claim 1, wherein the processor is further configured to automatically re-establish the previously established link as the new link between the first STA and the new AP.

3. The non-AP MLD of claim 2, wherein:
the processor is further configured to generate a capability indication message that indicates that the first STA of the non-AP MLD is capable of automatically re-establishing previously established links upon addition of new APs to the AP MLD, and
the transceiver of one of the STAs is further configured to transmit, to the AP MLD, the capability indication message.

4. The non-AP MLD of claim 2, wherein:
a previous traffic identifier (TID)-to-link mapping was applied to the previously established link, and
the processor is further configured to apply the previous TID-to-link mapping to the new link.

5. The non-AP MLD of claim 2, wherein the processor is further configured to:
determine whether identifying information or capability information associated with the new AP matches identifying information or capability information associated with a first AP with which the first STA was previously associated; and
based on a determination that at least some of the identifying information or capability information associated with the new AP matches the identifying information or capability information associated with the first AP, determine that the first STA had previously established the link with the new AP.

6. The non-AP MLD of claim 1, wherein the processor is further configured to generate a second message that includes a request to establish the new link and an indication of a preferred TID-to-link mapping for the new link, and
the transceiver of one of the STAs is further configured to transmit, to the AP MLD, the second message.

7. The non-AP MLD of claim 1, wherein the processor is configured to:
map all TIDs to the new link upon its establishment, or
map no TIDs to the new link upon its establishment.

8. The non-AP MLD of claim 1, wherein:
the first message includes an indication of a time at which the new AP will be added to the AP MLD, and
the processor is further configured to determine to establish the new link at or after the indicated time.

9. The non-AP MLD of claim 8, wherein the first message is received at least a predetermined threshold amount of time before the indicated time at which the new AP will be added to the AP MLD.

10. A method of wireless communication performed by a non-access point (AP) multi-link device (MLD) that comprises stations (STAs) that each comprise a transceiver configured to form a link with a corresponding AP of an AP MLD with which the non-AP MLD is associated, the method comprising:
receiving, from the AP MLD, a first message that includes an announcement of addition of a new AP to the AP MLD; and
determining to establish a new link between the new AP and the transceiver of a first of the STAs, wherein the first STA had previously established a link with the new AP.

11. The method of claim 10, further comprising:
automatically re-establishing the previously established link as the new link between the first STA and the new AP.

12. The method of claim 11, further comprising:
generating a capability indication message that indicates that the first STA of the non-AP MLD is capable of automatically re-establishing previously established links upon addition of new APs to the AP MLD; and
transmitting, to the AP MLD, the capability indication message.

13. The method of claim 11, wherein:
a previous traffic identifier (TID)-to-link mapping was applied to the previously established link, and
the method further comprises applying the previous TID-to-link mapping to the new link.

14. The method of claim 11, further comprising:
determining whether identifying information or capability information associated with the new AP matches identifying information or capability information associated with a first AP with which the first STA was previously associated; and
based on a determination that at least some of the identifying information or capability information associated with the new AP matches the identifying information or capability information associated with the first AP, determining that the first STA had previously established the link with the new AP.

15. The method of claim 10, further comprising:
generating a second message that includes a request to establish the new link and an indication of a preferred TID-to-link mapping for the new link; and
transmitting, to the AP MLD, the second message.

16. The method of claim 10, further comprising:
mapping all TIDs to the new link upon its establishment; or mapping no TIDs to the new link upon its establishment.

17. The method of claim 10, wherein:
the first message includes an indication of a time at which the new AP will be added to the AP MLD, and
the method further comprises determining to establish the new link at or after the indicated time.

18. The method of claim 17, wherein the first message is received at least a predetermined threshold amount of time before the indicated time at which the new AP will be added to the AP MLD.

19. An access point (AP) multi-link device (MLD) comprising:
APs each comprising a transceiver configured to form a link with a corresponding station (STA) of a non-AP MLD with which the AP MLD is associated; and
a processor operably coupled to the APs, the processor configured to generate a first message that includes an announcement of addition of a new AP to the AP MLD,
wherein the transceiver of one of the APs is further configured to transmit, to the corresponding STA of the non-AP MLD, the first message, and
wherein a new link is established between the transceiver of the new AP and a first of the STAs of the non-AP MLD after the first message is received at the non-AP MLD, wherein the first STA had previously established a link with the new AP.

20. The AP MLD of claim 19, wherein the previously established link is automatically re-established as the new link between the first STA and the new AP.
